(19) United States
(12) Patent Application Publication
(10) Pub. No.: US 2005/0276253 A1
(43) Pub. Date: Dec. 15, 2005

(54) Method and system for transmitting image data in ad-hoc mode of a wireless communication network

(75) Inventors: Jun-won Ho, Seoul (KR); Jun Choi, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/151,407

(22) Filed: Jun. 14, 2005

(30) Foreign Application Priority Data
Jun. 14, 2004 (KR) 2004-43449
Sep. 9, 2004 (KR) 2004-72077

(51) Int. Cl. H04Q 7/24

(52) U.S. Cl. 370/338; 370/312

(57) ABSTRACT

A method of transmitting image data in an ad hoc mode of a wireless communication network having an image forming apparatus and a plurality of hosts, the method including broadcasting a notice message indicating the presence of the image forming apparatus to the plurality of hosts, the plurality of hosts receiving the notice message and broadcasting the received notice message to other hosts; and one of the plurality of hosts receiving the notice message and requesting image formation transmitting image data to the image forming apparatus.

### CROSS-REFERENCE TO RELATED APPLICATIONS

This application claims the benefit of Korean Patent Application Nos. 2004-43449 and 2004-72077, filed on Jun. 14, 2004 and Sep. 9, 2004, respectively, in the Korean Intellectual Property Office, the disclosure of which are incorporated herein in their entirety by reference.

### BACKGROUND OF THE INVENTION

1. Field of the Invention

An aspect of the present invention relates to a method of forming an image using a wireless communication network, and more particularly, to a method and system for transmitting image data for image formation in an ad hoc mode of a wireless communication network.

2. Description of the Related Art

In a conventional infrastructure mode wireless communication network, users can perform printing by detecting an image forming device such as a printer or multi-functional device through an access point.

However, in an ad hoc mode of a wireless communication network in which the access point does not exist, if a host and the image forming device are not located within a range in which direct communication is possible, an image cannot be produced. That is, when the image forming device and the host that desires image formation are separated from each other beyond a distance in which wireless communication is possible in an ad hoc mode, the image forming device cannot produce the image. Another problem with the above wireless communication network is that security is weak.

### SUMMARY OF THE INVENTION

To solve the above and/or other problems, according to an aspect of the present invention, there is provided a method of transmitting image data to output an image by detecting an image forming device that is not located within a direct communication range in an ad hoc mode of a wireless communication network.

Also, according to another aspect of the present invention, there is provided a system for transmitting image data to output an image by detecting an image forming device that is not located within a direct communication range, in an ad hoc mode of a wireless communication network.

According to an aspect of the present invention, there is provided a method of transmitting image data in an ad hoc mode of a wireless communication network, the method including, when an image forming apparatus and a plurality of hosts constitute an ad hoc mode of a wireless communication network environment, broadcasting a notice message indicating the presence of the image forming apparatus to the hosts, the hosts receiving the notice message broadcasting the received notice message to other hosts; and one of the hosts receiving the notice message and requesting image formation transmitting image data to the image forming apparatus.

According to another aspect of the present invention, there is provided a system of transmitting image data in an ad hoc mode of a wireless communication network, the system including a notice message generation portion that broadcasts a notice message indicating the presence of the image forming apparatus to other hosts when an image forming apparatus and a plurality of hosts constitute an ad hoc mode of a wireless communication network environment, a notice message processing portion that receives and processes the notice message, and a transmission processing portion that transmits image data to the image forming apparatus.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating an ad hoc mode of a wireless communication network;

FIG. 2 is a flow chart for explaining a method of transmitting image data in an ad hoc mode of a wireless communication network according to an embodiment of the present invention;

FIG. 3 is a diagram illustrating an example of the packet structure of a notice message;

FIG. 4 is a flow chart for explaining Operation 102 of FIG. 2;

FIG. 5 is a diagram illustrating an example of the packet structure of notice message reference information;

FIG. 6 is a flow chart for explaining Operation 104 of FIG. 2;

FIG. 7 is a diagram illustrating an example of the packet structure of an image formation request message;

FIG. 8 is a diagram illustrating an example of the packet structure of an image formation response message;

FIG. 9 is a block diagram for explaining a system transmitting image data in an ad hoc mode of a wireless communication network according to an embodiment of the present invention;

FIG. 10 is a block diagram for explaining a notice message processing portion of FIG. 9;

FIG. 11 is a block diagram for explaining a transmission processing portion and an image formation response message generating portion of FIG. 9;

FIG. 12 is a flow chart for explaining a method of transmitting image data in an ad hoc mode of a wireless communication network according to another embodiment of the present invention;

FIG. 13 is a diagram illustrating an example of the packet structure of a notice message and a notice message code value; and

FIG. 14 is block diagram for explaining a system transmitting image data in an ad hoc mode of a wireless communication network according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

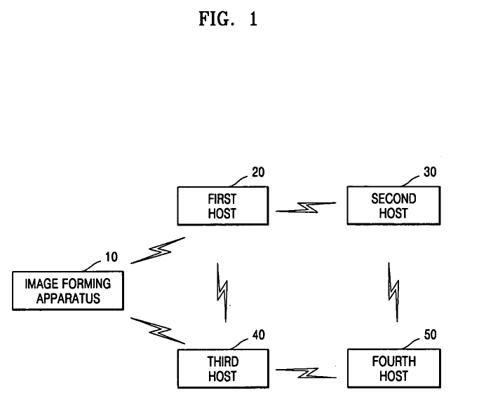

FIG. 1 is a view illustrating an ad hoc mode of a wireless communication network. Referring to FIG. 1, in a wireless communication network, an image forming apparatus 10 is located within a distance in which wireless communication in an ad hoc mode is possible with respect to a first host 20 and a third host 40. The first host 20 is located within a distance in which wireless communication in an ad hoc mode is possible with respect to not only the image forming apparatus 10 but also the second host 30 and the third host 40. The second host 30 is located within a distance in which wireless communication in an ad hoc mode is possible with respect to not only the first host 20 but also a fourth host 50. The third host 40 is located within a distance in which wireless communication in an ad hoc mode is possible with respect to not only the image forming apparatus 10 and the first host 20 but also the fourth host 50. The fourth host 50 is located within a distance in which wireless communication in an ad hoc mode is possible with respect to the second host 30 and the third host 40. However, the image forming apparatus 10 is not located within a distance in which wireless communication in an ad hoc mode is possible with respect to the second host 30 and the fourth host 50. If the second host 30 and the fourth host 50 desire to output image data using the image forming apparatus 10, since the image forming apparatus 10 is out of a wireless communication distance, an image cannot be output according to a conventional technology. However, according to an aspect of the present invention, an image can be output through the following operations.

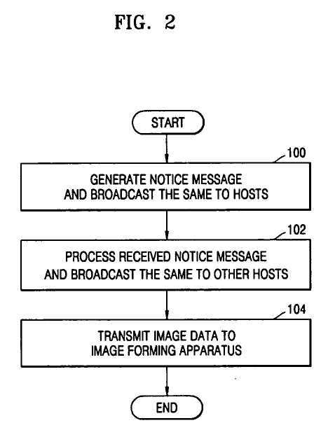

FIG. 2 is a flow chart for explaining a method of transmitting image data in an ad hoc mode wireless communication network according to an embodiment of the present invention. Referring to FIG. 2, the method of transmitting image data in an ad hoc mode wireless communication network includes operations of generating a notice message and broadcasting the generated notice message to hosts, processing a received notice message and broadcasting the processed notice message to other hosts, and transmitting image data to an image forming apparatus (Operations 100, 102, and 104).

First, when the image forming apparatus and a plurality of hosts constitute a wireless communication network environment in an ad hoc mode, a notice message indicating the presence of the image forming apparatus is regularly generated and broadcasted to the hosts (Operation 100). The notice message to inform the presence of the image forming apparatus is generated by the image forming apparatus and broadcasted to the hosts constituting the ad hoc mode of a wireless communication network.

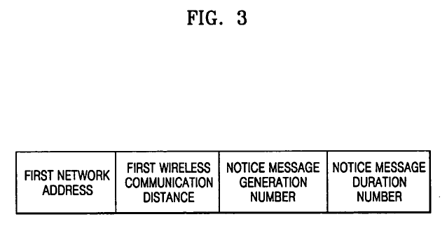

FIG. 3 shows an example of the packet structure of the notice message. The notice message includes a first network address indicating a network address of an image forming apparatus, a first wireless communication distance indicating a distance between the image forming apparatus and a host that receives the notice message, a notice message generation number indicating the order of generation of the notice message, and a notice message duration number indicating the duration of the notice message.

The first network address shows a network address of the image forming apparatus which is an Internet protocol address corresponding to an address to identify a transmission source and a transmission line during TCP/IP communications.

The first wireless communication distance is the number of hops between an image forming apparatus and a host that receives the notice message. The hops signify a process of transmitting a data packet from a router to another router in a packet exchange type network. In a network such as Internet using TCP/IP, the number of hops needed for a single packet to travel to a destination is included in a packet header. The distance between the image forming apparatus and the host that receives a notice message can be determined based on the number of hops. The first wireless communication distance of the image forming apparatus is set to “0”.

The notice message generation number is a number assigned whenever a notice message is generated. The notice message generation number indicates the order of generation of the notice message as a number increases whenever a notice message is generated. That is, as the notice message generation number increases, the notice message is generated more recently. The notice message generation number of the image forming apparatus is set to “1”.

The notice message duration number is reduced by a number whenever the notice message is broadcasted, so that no more notice messages are broadcasted when the notice message duration number becomes “0”. For example, when the notice message duration number is initially set to “10”, a notice message having a duration number of 10 is no longer broadcasted after broadcasting is performed ten times.

The notice message is regularly generated at an interval of 30 through 60 seconds. Whenever the notice message is newly generated, the notice message generation number increases. The generated notice message is broadcasted to the hosts constituting the ad hoc mode wireless communication network. The hosts to which the notice message is broadcasted are those located within a distance in which the notice message can be directly received in an ad hoc mode. For example, as shown in FIG. 1, the notice message generated by the image forming apparatus 10 is broadcasted to the first host 20 and the third host 40 which can perform direct wireless communication in an ad hoc mode with the image forming apparatus 10. Here, the notice message is not broadcasted to the second host 30 and the fourth host 50 because the second host 30 and the fourth host 50 and the image forming apparatus 10 generating the notice message do not constitute an environment in which wireless communication in an ad hoc mode is possible among the constituent parties.

After Operation 100, the hosts receiving the notice message process the notice message and broadcast the processed notice message to other hosts (Operation 102). For example, when the first host 20 shown in FIG. 1 receives a notice message, the first host 20 processes the first wireless communication distance and the notice message duration number of the information of the received notice message and transmits the processed notice message to the second host 30 and the third host 40.

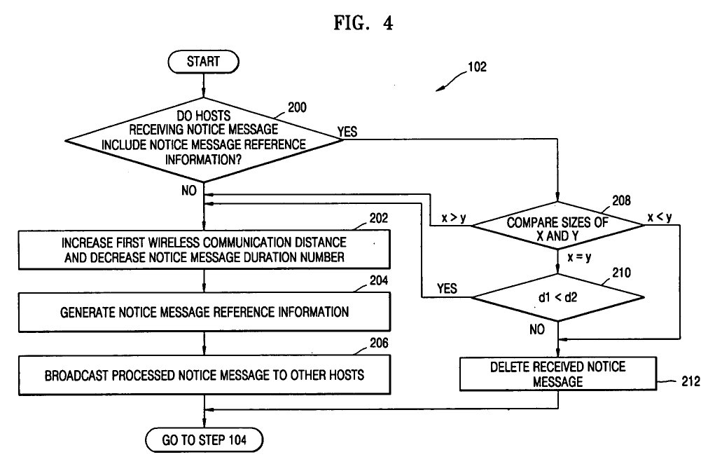

FIG. 4 is a flow chart for explaining Operation 102 of FIG. 2. Referring to FIG. 4, it is determined whether the hosts receiving the notice message have notice message reference information related to the image forming apparatus (Operation 200). The notice message reference information is the information related to the image forming apparatus that is generated based on the received notice message.

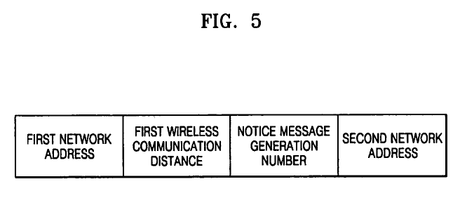

FIG. 5 is a diagram illustrating an example of the packet structure of the notice message reference information. Referring to FIG. 5, the notice message reference information includes the first network address of the received notice message, the first wireless communication distance of the received notice message, the notice message generation number of the received notice message, and a second network address indicating a network address of the image forming apparatus or the network address of the hosts that broadcast the received notice message. When the image forming apparatus transmits the notice message, the second network address includes a network address of the image forming apparatus. When another host transmits the notice message, the second network address includes a network address of the host that transmits the notice message.

When the hosts that receive the notice message do not include the notice message reference information, the first wireless communication distance of the received notice message is increased and the notice message duration number of the received notice message is decreased (Operation 202). For example, when the first host 20 shown in FIG. 1 receives a notice message, the first host 20 increases the number of hops corresponding to the first wireless communication distance among the information of the received notice message and decreases the notice message duration number by a predetermined number. The increase in the number of hops corresponding to the first wireless communication distance denotes the distance between the image forming apparatus 10 and the first host 20. That is, the number of hops of the first wireless communication distance of the notice message transmitted by the image forming apparatus 10 is initially set to “0”. When the number of hops changes to “1” as the number of hops increases at the host that receives the notice message, the image forming apparatus 10 and the first host 20 are separated a distance “1” corresponding to the number of hops. Meantime, when the notice message duration number of the notice message transmitted by the image forming apparatus 10 is set to “10”, the notice message duration number is decreased to “9” by one time broadcasting. Thus, the number “9” denotes that nine times of broadcasting of the notice message is left.

After Operation 202, notice message reference information in which the increased first wireless communication distance is reflected is generated (Operation 204). The first wireless communication distance with the increased distance is stored in the notice message reference information shown in FIG. 5. In addition to the first wireless communication distance with the increased distance, the notice message reference information includes a first network address of the received notice message, a notice message generation number of the received notice message, and a second network address corresponding to the image forming apparatus or the hosts broadcasting the received notice message. When the image forming apparatus broadcasts the notice message, the first network address and the second network address are the same.

After Operation 204, the processed notice message in which the increased first wireless communication distance and the decreased notice message duration number are reflected is broadcasted to other hosts (Operation 206). The first wireless communication distance and the notice message duration number of the information of the received notice message are processed. For example, when the image forming apparatus 10 transmits a notice message in which the first wireless communication distance is “1” and the notice message duration number is “10”, to the first host 20, the received first wireless communication distance is increased by “1” and set to “1” and the received notice message duration number is decreased by “1” and set to “9”. As the processed first wireless communication distance and the notice message duration number are updated, a newly processed notice message is generated. The newly processed notice message is broadcasted to the second host 30 and the third host 40.

When the decreased notice message duration number is updated to “0”, the processed notice message is deleted without being broadcasted. Since the broadcasting of the processed notice message is limited by the notice message duration number, the processed notice message is deleted.

When the hosts that receive the notice message have the notice message reference information in Operation 200, the notice message generation number of the received notice message is compared with the notice message generation number included in the notice message reference information of the hosts (Operation 208). For example, assuming that the notice message generation number of the received notice message is x and the notice message generation number included in the notice message reference information provided at the hosts is y, the sizes of x and y are compared.

When the notice message generation number of the received notice message is greater than the notice message generation number of the notice message reference information, the process goes to Operation 202. For example, assuming that the notice message generation number of the received notice message is x and the notice message generation number included in the notice message reference information provided at the hosts is y, when the size of x is greater than that of y, the information of the received notice message is newer than the information of the notice message reference information stored in the hosts. That is, a fact that the notice message generation number is relatively large signifies that the notice message is generated more recently. Thus, when x is greater than y, the program goes to Operation 202 where the first wireless communication distance of the received notice message is increased while the notice message duration number of the received notice message is decreased.

However, when the notice message generation number of the received notice message is the same as the notice message generation number of the notice message reference information, whether the first wireless communication distance included in the received notice message is smaller than the first wireless communication distance included in the notice message reference information is determined (Operation 210). For example, assuming that the notice message generation number of the received notice message is x and the notice message generation number included in the notice message reference information provided at the hosts is y, when the sizes of x and y are the same, the information of the received notice message is the same as that of the notice message reference information stored in the hosts. Assuming that the first wireless communication distance included in the received notice message is d1 and the first wireless communication distance included in the notice message reference information provided at the hosts is d2, when the sizes of the x and y are the same, it is determined whether the size of d1 is less than that of d2.

When the first wireless communication distance of the received notice message is smaller than the first wireless communication distance of the notice message reference information, the program goes to Operation 202. For example, assuming that the first wireless communication distance included in the received notice message is d1 and the first wireless communication distance included in the notice message reference information provided at the hosts is d2, when the size of d1 is less than that of d2, the distance between the image forming apparatus broadcasting the received notice message and the host that receives the notice message is relatively shorter than the distance between the host and the image forming apparatus that is traceable according to the notice message reference information. Although communication is made between the same image forming apparatus and the host, since the communication can be made via other hosts in a network, the network distance cannot be always the same. Thus, when the information of the received notice message and the information of the notice message reference information provided at the host have the same content, Operation 202 is performed based on the information of the newly received notice message.

However, in Operation 210, when the first wireless communication distance of the received notice message is not less than the first wireless communication distance of the notice message reference information, the received notice message is deleted (Operation 212). For example, assuming that the first wireless communication distance included in the received notice message is d1 and the first wireless communication distance included in the notice message reference information provided at the hosts is d2, when the size of d1 is not less than that of d2, the distance between the image forming apparatus broadcasting the received notice message and the host that receives the notice message is relatively longer than the distance between the host and the image forming apparatus that is traceable according to the notice message reference information. Thus, when the information of the received notice message and the information of the notice message reference information provided at the host have the same content, the notice message reference information already stored in the host needs to be maintained as it is. Since the received notice message is unnecessary information, the received notice message is deleted.

In Operation 208, when the notice message generation number of the received notice message is smaller than the notice message generation number of the notice message reference information, the program goes to Operation 212 where the received notice message is deleted. For example, assuming that the notice message generation number of the received notice message is x and the notice message generation number included in the notice message reference information provided at the hosts is y, when the size of x is less than that of y, the information of the notice message reference information stored in the hosts is newer than the information of the received notice message. That is, a fact that the notice message generation number included in the notice message reference information is relatively large signifies that the notice message reference information is newer than the information of the received notice message. Thus, when the size of x is less than that of y, since the received notice message is unnecessary information, the program goes to Operation 212 where the received notice message is deleted.

After Operation 102, a host requesting image forming transmits image data for forming an image to the image forming apparatus (Operation 104)

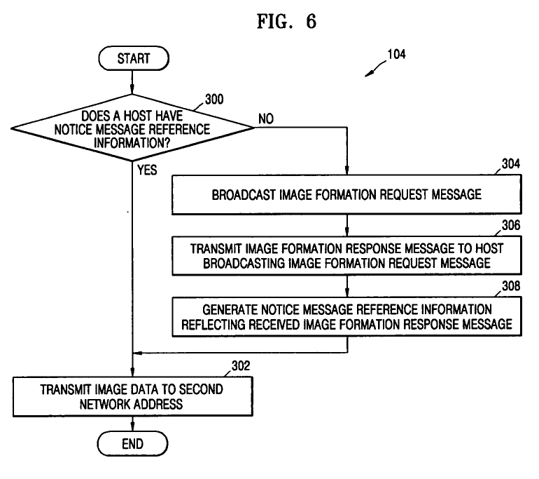

FIG. 6 is a flow chart for explaining Operation 104 of FIG. 2. Referring to FIG. 6, it is determined whether a host requesting image formation has notice message reference information (Operation 300). For example, when a user of the second host 30 shown in FIG. 1 requests image formation, it is determined whether the second host 30 has a notice message reference information.

When the host requesting image formation has the notice message reference information, the host transmits image data to a second network address included in the notice message reference information (Operation 302). For example, when the user of the second host 30 of FIG. 1 requests image formation and the second host 30 has the notice message reference information, the second host 30 transmits image data to the second network address, which is one of the first host 20 or the fourth host 50, included in the notice message reference information. As described above, the second network address is a network address of the image forming apparatus and/or the hosts broadcasting a received notice message. In the present example, the second host 30 receives a notice message from the first host 20 and/or the fourth host 50 and generates and stores notice message reference information based on the received notice message. Thus, the second host 30 has the second network address corresponding to a network address of the first host 20 and/or the fourth host 50 broadcasting the notice message, as the notice message reference information.

When the network address of the first host 20 is provided as the second network address of the notice message reference information, the second host 30 transmits the image data to the first host 20. Here, the second host 30 cannot transmit the image data directly to the image forming apparatus 10 because the wireless communication distance between the second host 30 and the image forming apparatus 10 is too long to communicate with each other in an ad hoc mode network environment.

When the image data is transmitted from the second host 30 to the first host 20, the first host 20 retransmits the received image data to the image forming apparatus 10 which is located within a distance in which wireless communication is possible. When the image forming apparatus 10 receives the image data, the received image data is output. Consequently, although the second host 30 cannot directly transmit the image data to the image forming apparatus 10 to output an image in an ad hoc mode wireless network environment, the second host 30 make the image outputted by indirectly transmitting the image data to the image forming apparatus 10 via the first host 20 which is located within a distance in which wireless communication is possible.

When the host requesting the image formation does not have the notice message reference information in Operation 300, the host broadcasts an image formation request message requesting image formation (Operation 304). For example, a user of the fourth host 50 of FIG. 1 requests image formation and the fourth host 50 does not have the notice message reference information, the fourth host 50 generates an image formation request message and broadcasts the generated image formation request message to the third host 40 and the second host 30 which are located within a distance in which wireless communication is possible.

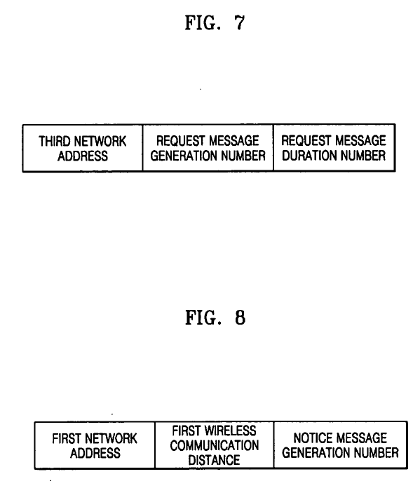

The image formation request message is a message to request image forming. FIG. 7 shows an example of the packet structure of an image formation request message. The image formation request message includes a third network address indicating a network address of a host requesting image forming, a request message generation number indicating the order of generation of the image formation request message, and a request message duration number indicating the duration of the image formation request message, as information.

The third network address includes an Internet protocol address of a host requesting image formation as a network address.

The request message generation number is a number assigned whenever an image formation request message is generated. The request message generation number indicates the order of generation of the image formation request message as a number increases whenever the image formation request message is generated. That is, as the request message generation number increases, the image formation request message is generated more recently. The request message generation number of the host is set to “1”.

Since the request message duration number is decreased by a predetermined number whenever the image formation request message is broadcasted, when the request message duration number is “0”, the image formation request message is no longer broadcasted. For example, when the request message duration number is initially set to “30”, a notice message having a duration number “30” is no longer broadcasted after the notice message is broadcasted 30 times.

After Operation 304, the hosts receiving the image formation request message or the image formation apparatus transmits an image formation response message as information on the image forming apparatus needed to form an image, to the host broadcasting the image formation request message (Operation 306).

The image formation response message as information on the image forming apparatus needed to form an image is generated based on the notice message reference information provided at the host. The image formation response message is information informing the host broadcasting the image formation request message that the host generating the image formation response message can receive image data and transmit the image data directly or indirectly to the image forming apparatus.

FIG. 8 is a diagram illustrating an example of the packet structure of an image formation response message. The image formation response message includes the first network address, the first wireless communication distance, and the notice message generation number of the notice message reference information.

For example, when a user of the fourth host 50 of FIG. 1 requests image formation and the notice message reference information does not exist in the fourth host 50, an image formation request message is generated by the fourth host 50 and broadcasted to the second and third hosts 30 and 40 which are located within a distance in which wireless communication is possible. The second and third hosts 30 and 40 receiving the image formation request message generate an image forming response message based on the notice message reference information stored in each of the hosts and transmit the generated image formation response message to the fourth host 50 broadcasting the image formation request message.

After Operation 306, the host that receives the image formation response message generates notice message reference information reflecting the received image formation response message and the program goes to Operation 302 (Operation 308). The host that receives the image formation response message generates the notice message reference information of FIG. 5 based on the first network address, the first wireless communication distance, and the notice message generation number of the received image formation response message. The second network address is a network address of the host that transmits the image formation response message.

After Operation 308, the program goes to Operation 302 where the image data is transmitted to the second network address of the generated notice message reference information. When the host broadcasting the image formation request message receives two or more image formation response messages, the image data is transmitted to the second network address corresponding to a network address of a host that transmits information having the smallest first wireless communication distance among the hosts transmitting the image formation response messages. For example, when the fourth host 50 receives separate image formation response messages from the second and/or third hosts 30 and 40, the fourth host 50 compares the first wireless communication distance included in each of the image formation response messages of the second and third hosts 30 and 40 and transmits the image data to the host having a relatively smaller communication distance.

A fact that the first wireless communication distance is relatively small signifies that the wireless communication distance to the image forming apparatus in a network is short. Thus, it is appropriate that the image data is transmitted to the host having a short wireless communication distance. When the first wireless communication distance included in the image formation response message transmitted from the third host 40 is shorter than that included in the image formation response message transmitted from the second host 30, the fourth host 50 transmits the image data to the second network address of the notice message reference information corresponding to the network address of the third host 40.

The third host 40 transmits the received image data to the image forming apparatus 10 that is located within a distance in which wireless communication is possible. The image forming apparatus 10 receives the image data and outputs the received image data. Consequently, although the fourth host 50 cannot directly transmit the image data to the image forming apparatus 10 to output an image in an ad hoc mode wireless network environment, the fourth host 50 creates the image by indirectly transmitting the image data to the image forming apparatus 10 via the third host 40 which is located within a distance in which wireless communication is possible.

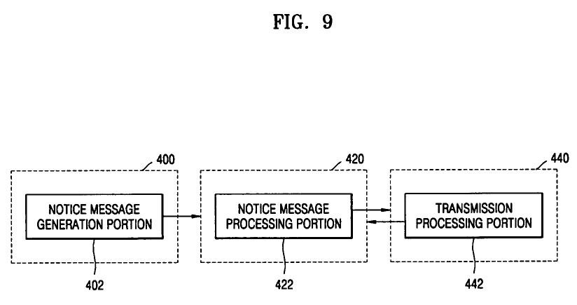

FIG. 9 is a block diagram for explaining a system transmitting image data in an ad hoc mode wireless communication network according to an embodiment of the present invention. Referring to FIG. 9, the system includes a notice message generation portion 402, a notice message processing portion 422, and a transmission processing portion 442. The image forming apparatus 400 constitutes an ad hoc mode wireless communication network environment with a plurality of hosts. The notice message generation portion 402 periodically generates a notice message indicating the presence of the image forming apparatus 400 to broadcast the notice message to the hosts. The notice message is periodically generated at an interval of 30 through 60 seconds. The generated notice message is broadcasted to the hosts constituting the ad hoc mode wireless communication network. The hosts to which the notice message is transmitted are hosts located within a distance at which the notice message can be directly received in an ad hoc mode. A first host 420 shown in FIG. 9 is a host located within a distance in which wireless communication is possible so that the first host 420 can directly receive the notice message from the image forming apparatus 400.

As shown in FIG. 3, the notice message includes a first network address indicating a network address of an image forming apparatus, a first wireless communication distance indicating a distance between the image forming apparatus and a host that receives the notice message, a notice message generation number indicating the order of generation of the notice message, and a notice message duration number indicating the duration of the notice message, as information. Since the notice message is already described above, a detailed description thereof will be omitted.

As shown in FIG. 9, the notice message processing portion 422 is provided at the first host 420 receiving the notice message. The notice message processing portion 422 receives and processes the notice message and broadcasts the processed notice message to the hosts located within a distance in which the processed notice message can be directly received in an ad hoc mode. As shown in FIG. 9, the notice message processing portion 422 broadcasts the processed notice message to a second host 440 located within a distance in which the processed notice message can be directly received.

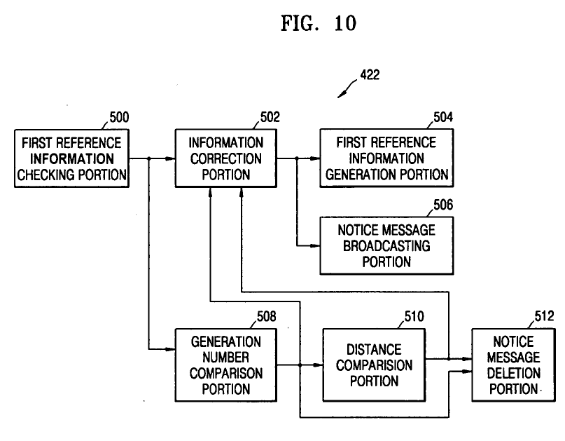

FIG. 10 is a block diagram for explaining the notice message processing portion 422 of FIG. 9. Referring to FIG. 10, the notice message processing portion 422 includes a first reference information checking portion 500, an information correction portion 502, a first reference information generation portion 504, a notice message broadcasting portion 506, a generation number comparison portion 508, a distance comparison portion 510, and a notice message deletion portion 512.

The first reference information checking portion 500, in response to a received notice message, checks whether notice message reference information related to the image forming apparatus is included in one's own host and outputs a result of the check to the information correction portion 502 and to the generation number comparison portion 508.

As shown in FIG. 5, the notice message reference information includes a first network address, a first wireless communication distance, and a notice message generation number of the notice message. In addition, the notice message reference information includes a second network address which indicates a network address of the image forming apparatus and/or the hosts broadcasting the notice message.

The information correction portion 502, in response to a result output by the first reference information checking portion 500, increases the first wireless communication distance of the received notice message and decreases the notice message duration number of the received notice message. In response to a result of output by the first reference information checking portion 500 that the notice message reference information is not included in one's own host, the information correction portion 502 increases the number of hops corresponding to the first wireless communication distance of the received notice message, decreases the notice message duration number of the received notice message by a predetermined number, and outputs a processed notice message to the first reference information generation portion 504 and the notice message broadcasting portion 506.

The first reference information generation portion 504 generates notice message reference information in which the increased first wireless communication distance is reflected. When a processed notice message including the increased first wireless communication distance is received from the information correction portion 502, the first reference information generation portion 504 stores the increased first wireless communication distance as new information on the first wireless communication distance of the notice message reference information, the first network address and the notice message generation number based on the information of the received notice message, and a network address of an apparatus broadcasting the notice message on the second network address. When the notice message reference information is already provided, the first reference information generation portion 504 instructs one's own host to update the information of the provided notice message reference information.

The notice message broadcasting portion 506 broadcasts the processed notice message, in which the increased first wireless communication distance and the decreased notice message duration number are reflected, to other hosts. When the processed notice message is received from the information correction portion 502, the notice message broadcasting portion 506 broadcasts the processed notice message to the hosts located within a distance in which wireless communication is possible in an ad hoc mode wireless communication network environment.

When the decreased notice message duration number is “0”, it is characteristic that the notice message broadcasting 506 does not broadcast the processed notice message and deletes the processed notice. A fact that the notice message duration number is 0 signifies that no more notice message will be broadcasted. That is, since the broadcasting of the processed notice message is limited by the notice message duration number, the notice message broadcasting portion 506 deletes the processed notice message.

The generation number comparison portion 508, in response to the result output by the first reference information checking portion 500, compares the notice message generation number included in the received notice message and the notice message generation number included in the notice message reference information provided at the host. In response to the result output by the first reference information checking portion 500 that the notice message reference information is provided at one's own host, the generation number comparison portion 508 compares the notice message generation number of the received notice message and the notice message generation number of the notice message reference information provided at the host and outputs a result of comparison to the information correction portion 502, the distance comparison portion 510, and the notice message deletion portion 512.

When a comparison result that the notice message generation number of the received notice message is greater than the notice message generation number of the notice message reference information provided at the host is received from the generation number comparison portion 508, the information correction portion 502 increases the first wireless communication distance of the received notice message and decreases the notice message duration number of the received notice message. A fact that the notice message generation number of the received notice message is greater than the notice message generation number of the notice message reference information provided at the host signifies that the information of the received notice message is newer than that of the notice message reference information provided at the host.

When a comparison result, that the notice message generation number of the received notice message is the same as the notice message generation number of the notice message reference information provided at the host, is received from the generation number comparison portion 508, the distance comparison portion 510 checks whether the first wireless communication distance of the received notice message is smaller than the first wireless communication distance of the notice message reference information provided at the host and outputs a result of comparison to the information correction portion 502 and the notice message deletion portion 512. A fact that the notice message generation number of the received notice message is the same as the notice message generation number of the notice message reference information provided at the host signifies that the information of the received notice message is the same as that of the notice message reference information provided at the host.

When a comparison result, that the first wireless communication distance of the received notice message is smaller than the first wireless communication distance of the notice message reference information provided at the host, is received from the distance comparison portion 510, the information correction portion 502 increases the first wireless communication distance of the received notice message and decreases the notice message duration number of the received notice message. A fact that the first wireless communication distance of the received notice message is smaller than the first wireless communication distance of the notice message provided at the host signifies that the distance between the image forming apparatus broadcasting the received notice message and the host that receives the notice message is relatively closer in a network than the distance between the host and the image forming apparatus that can be traceable by the notice message reference information.

The notice message deletion portion 512 in response to a result of the comparison output by the distance comparison portion 510 deletes the received notice message. When a comparison result, that the first wireless communication distance of the received notice message is not smaller than the first wireless communication distance of the notice message reference information provided at the host, is received from the distance comparison portion 510, the notice message deletion portion 512 deletes the received notice message.

When a comparison result, that the notice message generation number of the received notice message is smaller than the notice message generation number of the notice message reference information provided at the host, is received from the generation number comparison portion 510, the notice message deletion portion 512 deletes the received notice message. A fact that the notice message generation number of the received notice message is smaller than the notice message generation number of the notice message reference information provided at the host indicates that the notice message reference information is newer than the information of the received notice message.

As shown in FIG. 9, the transmission processing portion 442 is provided at the second host 440 from where a user requests image formation. The transmission processing portion 442 transmits image data for the image formation to the image forming apparatus 400 via the first host 420.

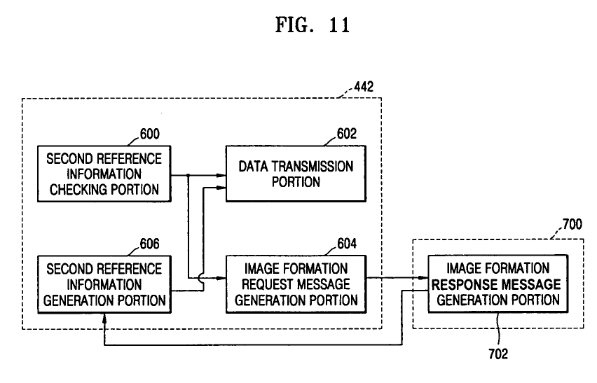

FIG. 11 is a block diagram for explaining the transmission processing portion 442 and the image formation response message generating portion 702 of FIG. 9. Referring to FIG. 11, the transmission processing portion 442 includes a second reference information checking portion 600, a data transmission portion 602, an image formation request message generation portion 604, and a second reference information generation portion 606.

The second reference information checking portion 600 checks whether the notice message reference information is present. When a user of the second host 440 requests from the second host 440 to form an image, the second reference information checking portion 600 checks whether the notice message reference information is provided at the second host 440 and outputs a result of the check to the data transmission portion 602 and the image formation request message generation portion 604.

When the notice message reference information provided at the second host 440 is received from the second reference information checking portion 600, the data transmission portion 602 transmits image data to the second network address included in the notice message reference information provided at the second host 440. The second network address is a network address of the first host 420 shown in FIG. 9.

The second host 440 transmits the image data to the first host 420. The second host 440 is not able to transmit the image data directly to the image forming apparatus 400 because the wireless communication distance between the second host 440 and the image forming apparatus 400 is too long to communicate with each other in the ad hoc mode network environment. However, when the image data of the second host is transmitted to the first host 420, the first host 420 transmits the received image data to the image forming apparatus 400 with which wireless communication is possible. The image forming apparatus 400 receives the image data and outputs the received image data.

When the host broadcasting the image formation request message receives two or more image formation response messages, the data transmission portion 602 transmits the image data to the second network address corresponding to the network address of the host that transmits information having the least size of the first wireless communication distance among the hosts transmitting the image formation response messages.

When the second host 440 does not include the notice message reference information from the second reference information checking portion 600, the image formation request message generation portion 604 generates and broadcasts an image formation request message requesting image formation. The image formation request message includes a third network address indicating a network address of a host requesting image formation, a request message generation number of the image formation request message, and the request message duration number of the image formation request message.

As shown in FIG. 11, the image formation response message generation portion 702 is included in a host 700 that receives the image formation request message. The image formation response message generation portion 702 generates an image formation response message of the image formation apparatus needed to form an image and transmits the generated image formation response message to the host broadcasting the image formation request message. The image formation response message includes a first network address of the notice message reference information, the first wireless communication distance, and the notice message generation number. The image formation response message is generated based on the notice message reference information provided at the host.

The image formation response message generation portion 702 transmits the image formation response message to the second reference information generation portion 606 of the host broadcasting the image formation request message. The second reference information generation portion 606 generates a notice message reference information in which the received image formation response message is reflected and outputs the generated notice message reference information to the data transmission portion 602. The second reference information generation portion 606 receiving the image formation response message generates the notice message reference information as shown in FIG. 5 based on the first network address, the first wireless communication distance, and the notice message generation number of the image formation response message. The second network address is a network address of the host that transmits the image formation response message.

When the notice message reference information is received from the second reference information generation portion 606, the data transmission portion 602 transmits the image data to the second network address included in the received notice message reference information.

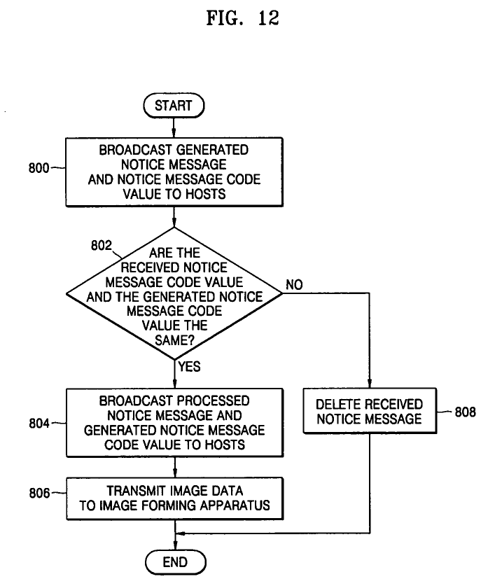

FIG. 12 is a flow chart explaining a method of transmitting image data in an ad hoc mode of a wireless communication network according to another embodiment of the present invention.

When an image forming apparatus and a plurality of hosts constitute an ad hoc mode of a wireless communication network environment, a notice message indicating the existence of the image forming apparatus is periodically generated, a notice message code value is generated using the generated notice message, and the generated notice message and the notice message code value are broadcasted to the host (Operation 800). As described above, the notice message includes a first network address indicating a network address of the image forming apparatus, a first wireless communication distance indicating a distance between the image forming apparatus and the host that receives the notice message, a notice message generation number indicating the order of generation of the notice message, and a notice message duration number indicating the duration of the notice message. The notice message code value is generated using the first network address, the first wireless communication distance, the notice message generation number, and the notice message duration number corresponding to the information of the notice message.

The notice message code value can be calculated using various code algorithms. The code algorithm includes a Hash function, a message authentication code (MAC), and a block and stream code. The Hash function is a function of compressing an input message having an arbitrary length into an output value having a fixed length and used for the integrity of data or authentication of a message. The MAC is an algorithm for checking a change of the content of a file or the integrity of data exchanged on a network. In particular, according to an aspect of the present invention, the code algorithm of an HMAC can be adopted to calculate the notice message code value. The HMAC is an algorithm generating the MAC using the Hash function. “MD5”, “SHA1”, and “RMD160” can be used as the Hash function. That is, the notice message code value is calculated by adopting the code algorithm of the HMAC and using the first network address, the first wireless communication distance, the notice message generation number, and the notice message duration number.

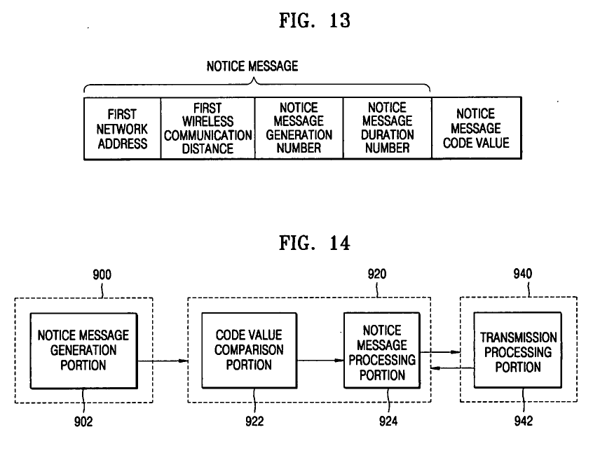

FIG. 13 is a diagram illustrating an example of the packet structure of a notice message and a notice message code value. Referring to FIG. 13, the calculated notice message code value is added to the packet structure of the generated notice message.

As shown in FIG. 13, the notice message and the notice message code value are broadcasted to the hosts in packets. The hosts to which the notice message and the notice message code value are transmitted are those disposed at a position where the notice message and the notice message code value can be directly received in an ad hoc mode.

After Operation 800, the hosts receiving the notice message and the notice message code value generate a notice message code value using the received notice message and compare the generated notice message code value with the received notice message code value to determine whether they are identical (Operation 802). The hosts receiving the notice message and the notice message code value generate a notice message code value using the first network address of the received notice message, the first wireless communication distance, the notice message generation number, and the notice message duration number. The hosts compare the generated notice message code value with the notice message code value received with the notice message and determine whether the code values match.

If the generated notice message code value matches the received notice message code value, the notice message is processed, the notice message code value is generated using the processed notice message, and the processed notice message and the generated notice message code value are broadcasted to other hosts (Operation 804). The match between the generated notice message code value and the received notice message code value signifies that the information of the first network address of the received notice message, the first wireless communication distance, the notice message generation number, and the notice message duration number are kept safe during transmission so that the information is not damaged. That is, the match between the generated notice message code value and the received notice message code value signifies that the notice message is safely transmitted to the hosts. If it is determined that the notice message is safely transmitted to the hosts, the received notice message is processed. Since the process of the notice message is the same as that described above, a detailed description thereof will be omitted herein. A new notice message code value is generated in the above-described method using the information of the processed notice message. The generated notice message code value and the processed notice message are broadcasted to other hosts.

After Operation 804, a host requesting image formation transmits image data for the image formation to the image forming apparatus (Operation 806). Since Operation 806 is the same process as Operation 104 that is described above, a detailed description thereof will be omitted herein.

In Operation 802, if the generated notice message code value does not match the received notice message code value, the received notice message is deleted (Operation 808). The mismatch between the generated notice message code value and the received notice message code value signifies that a breach of security has occurred during transmission of any of the information of the first network address of the received notice message, the first wireless communication distance, the notice message generation number, and the notice message duration number such that the information is damaged. Thus, since such information of the notice message is damaged and is not useful, the host receiving the notice message removes the damaged notice message. As a result, the hosts can receive only the notice message whose security is kept safe, by comparing the notice message code values, and then, broadcast this notice message only.

FIG. 14 is block diagram explaining a system transmitting image data in an ad hoc mode wireless communication network according to another embodiment of the present invention. The system includes a notice message generation portion 902, a code value comparison portion 922, a notice message processing portion 924, and a transmission processing portion 942.

The notice message generation portion 902 is provided in the image forming apparatus 900. When the image forming apparatus 900 and a plurality of hosts constitutes an ad hoc mode wireless communication network environment, the notice message generation portion 902 periodically generates a notice message indicating the presence of the image forming apparatus 900, generates a notice message code value using the generated notice message, and broadcasts the notice message and the notice message code value to the hosts. The notice message generation portion 902 of FIG. 14, unlike the notice message generation portion 402 of FIG. 9, generates the notice message code value using the generated notice message in addition to periodically generating the notice message. The notice message generation portion 902 adopts the HMAC code algorithm and generates the first network address of the received notice message, the first wireless communication distance, the notice message generation number, and the notice message duration number. The notice message generation portion 902 broadcasts the notice message and the notice message code value to the hosts located within a distance in which the notice message and the notice message code value can be directly received in an ad hoc mode.

The code value comparison portion 922 is provided in a host 920. The code value comparison portion 922 generates a notice message code value using the received notice message and compares the generated notice message code value with the received notice message code value to determine whether code values are identical. The code value comparison portion 922 generates the notice message code value using the first network address of the received notice message, the first wireless communication distance, the notice message generation number, and the notice message duration number. The code value comparison portion 922 compares the received notice message code value with the generated notice message code value to determine whether the code values are identical and outputs the result of comparison to the notice message processing portion 924.

The notice message processing portion 924 is provided in the host 920. The notice message processing portion 924 in response to the result output by the code value comparison portion 922 processes the notice message, generates a notice message code value using the processed notice message, and broadcasts the processed notice message and the generated notice message code value to other hosts. The notice message processing portion 924 of FIG. 14, unlike the notice message processing portion 422 of FIG. 9, adopts the HMAC code algorithm and generates the notice message code value.

The transmission processing portion 942 transmits the image data for forming an image to the image forming apparatus 900. Since the configuration and operation of the transmission processing portion 942 of FIG. 14 is the same as those of the transmission processing portion 442 of FIG. 9, a detailed description thereof will be omitted herein.

The embodiments of the present invention can also be embodied as computer readable codes/instructions/programs on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the method and system for transmitting image data in an ad hoc mode of a wireless communication network according to an aspect of the present invention have been particularly shown and described with reference to embodiments thereof, it will be understood by those skilled in the art that various changes in form and details may be made therein without departing from the spirit and scope of the invention as defined by the appended claims.

As described above, in the method and system for transmitting image data in an ad hoc mode wireless communication network according to aspects of the present invention, an image forming apparatus that is not located within a direct communication range is searched using a network device constituting a network so that an image can be produced. According to another aspect of the present invention, the method and system includes a plurality of image forming apparatuses forming part of the ad hoc mode wireless communication network,

1. A method of transmitting image data in an ad hoc mode of a wireless communication network including an image forming apparatus and a plurality of hosts, the method comprising:
broadcasting a notice message indicating a presence of the image forming apparatus to the plurality of hosts;
receiving the notice message at at least one of the plurality of hosts and broadcasting the received notice message to at least another one of the plurality of hosts; and
the at least one of the plurality of hosts receiving the notice message, requesting image formation and transmitting image data to the image forming apparatus.

2. The method as claimed in claim 1, wherein the notice message comprises a first network address indicating a network address of the image forming apparatus, a first wireless communication distance indicating a distance between the image forming apparatus and a host that receives the notice message, a notice message generation number indicating an order of generation of the notice message, and a notice message duration number indicating the duration of the notice message.

3. The method as claimed in claim 2, wherein the receiving of the notice message and broadcasting of the received notice message comprises:
determining whether the at least one of the plurality of hosts receiving the notice message is provided with the notice message reference information as relevant information of the image forming apparatus;
if the at least one of the plurality of hosts that receives the notice message does not have the notice message reference information, increasing the first wireless communication distance of the received notice message and decreasing the notice message duration number of the received notice message;
generating the notice message reference information in which an increased first wireless communication distance is reflected; and
broadcasting the notice message in which the increased first wireless communication distance and the decreased notice message duration number are reflected to the at least another one of the plurality of hosts.

4. The method as claimed in claim 3, wherein the notice message reference information comprises the first network address of the received notice message, the first wireless communication distance of the received notice message, the notice message generation number of the received notice message, and a second network address indicating a network address of the image forming apparatus or the at least one of the plurality of hosts that broadcast the received notice message.

5. The method as claimed in claim 4, wherein the receiving of the notice message and broadcasting of the received notice message further comprises:
if the at least one of the plurality of hosts that receives the notice message has the relevant notice message reference information, comparing the notice message generation number of the received notice message with the notice message generation number included in the notice message reference information provided at the plurality of hosts;
if the notice message generation number of the received notice message is the same as the notice message generation number included in the notice message reference information provided at the plurality of hosts, determining whether the first wireless communication distance of the received notice message is less than the first wireless communication distance included in the notice message reference information provided at the plurality of hosts; and
if the first wireless communication distance of the received notice message is not less than the first wireless communication distance included in the notice message reference information provided at the plurality of hosts, deleting the received notice message,
when the notice message generation number of the received notice message is greater than the notice message generation number included in the notice message reference information provided at the plurality of hosts, or when the first wireless communication distance of the received notice message is less than the first wireless communication distance included in the notice message reference information provided at the plurality of hosts, increasing the first wireless communication distance of the received notice message and decreasing the notice message duration number of the received notice message, and when the notice message generation number of the received notice message is less than the notice message generation number included in the notice message reference information provided at the plurality of hosts, deleting the received notice message.

6. The method as claimed in claim 4, wherein the transmitting of the image data to the image forming apparatus comprises:
determining whether one of the plurality of hosts requesting the image formation has the notice message reference information;
if the one of the plurality of hosts requesting the image formation has the notice message reference information, transmitting the image data to the second network address included in the notice message reference information;
if the one of the plurality of hosts requesting the image formation does not have the notice message reference information, broadcasting an image formation request message requesting image formation;
from the plurality of hosts or the image forming apparatus that receive the image formation request message, transmitting an image formation response message, as information of the image forming apparatus needed for image formation, to the host broadcasting the image formation request message; and
the plurality of hosts receiving the image formation response message generating the notice message reference information in which the received image forming response message is reflected and proceeding to transmit the image data to the second network address included in the notice message reference information.

7. The method as claimed in claim 6, wherein, in the transmission of the image data. to the image forming apparatus, the image formation request message comprises a third network address indicating a network address of a host requesting image forming, a request message generation number indicating the order of generation of the image formation request message, and a request message duration number indicating the duration of the image formation request message.

8. The method as claimed in claim 7, wherein, in the transmission of the image data to the image forming apparatus, the image formation response message comprises the first network address, the first wireless communication distance, and the notice message generation number of the notice message reference information, as information.

9. The method as claimed in claim 8, wherein, in the transmission of the image data to the second network address, when one of the plurality of hosts broadcasting the image formation request message receives two or more image formation response messages, the image data is transmitted to the second network address corresponding to a network address of a host having transmitted information having the smallest size in the first wireless communication distance among the plurality of hosts that transmit the image formation response messages.

10. The method as claimed in claim 1, wherein, in the broadcasting of the notice message indicating the presence of the image forming apparatus, a notice message code value is generated by coding the notice message and broadcasted to the hosts with the notice message.

11. The method as claimed in claim 10, further comprising comparing whether the notice message code value generated by coding the received notice message that is broadcasted is identical to a received notice message code value that is broadcasted, and when the generated notice message code value is identical to the received notice message code value, processing the received notice message, and broadcasting the processed notice message and the generated notice message code value to other hosts.

12. The method as claimed in claim 11, further comprising deleting the received notice message when the generated notice message code value is not identical to the received notice message code value.

13. A system of transmitting image data in an ad hoc mode of a wireless communication network, the system comprising:
a notice message generation portion that broadcasts a notice message indicating a presence of an image forming apparatus to a plurality of hosts when the image forming apparatus and the plurality of hosts constitute an ad hoc mode of a wireless communication network environment;
a notice message processing portion that receives and processes the notice message; and
a transmission processing portion that transmits the image data to the image forming apparatus.

14. The system as claimed in claim 13, wherein the notice message comprises a first network address indicating a network address of the image forming apparatus, a first wireless communication distance indicating a distance between the image forming apparatus and the plurality of hosts that receive the notice message, a notice message generation number indicating the order of generation of the notice message, and a notice message duration number indicating the duration of the notice message.

15. The system as claimed in claim 14 wherein the notice message processing portion comprises:
a first reference information checking portion that, in response to the received notice message, checks whether notice message reference information is provided at the plurality of hosts;
an information correction portion that, in response to a result of checking by the first reference information checking portion, increases the first wireless communication distance of the received notice message and decreases the notice message duration number of the received notice message;
a first reference information generation portion that generates notice message reference information in which an increased first wireless communication distance is reflected;
a notice message broadcasting portion that broadcasts the processed notice message in which the increased first wireless communication distance and the decreased notice message duration number are reflected, to the plurality of hosts;
a generation number comparison portion that, in response to the result of the first reference information checking portion, compares the notice message generation number of the received notice message with the notice message generation number included in the notice message reference information provided at the plurality of hosts;
a distance comparison portion that, in response to the check by the generation number comparison portion, checks whether the first wireless communication distance of the received notice message is less than the first wireless communication distance included in the notice message reference information provided at the plurality of hosts; and
a notice message deletion portion that, in response to the result of the distance comparison portion, deletes the received notice message.

16. The system as claimed in claim 15, wherein the notice message reference information comprises the first network address of the received notice message, the first wireless communication distance of the received notice message, the notice message generation number of the received notice message, and a second network address indicating a network address of the image forming apparatus or the plurality of hosts that broadcast the received notice message.

17. The system as claimed in claim 16, wherein the transmission processing portion comprises:
a second reference information checking portion that checks whether the plurality of hosts requesting the image formation have the notice message reference information;
a data transmission portion that, in response to the check by the second reference information checking portion, transmits the image data to the second network address included in the notice message reference information;
an image formation request message generation portion that, in response to of the check by the second reference information checking portion, generates and broadcasts an image formation request message requesting image formation;
an image formation response message generation portion that transmits an image formation response message as information of the image forming apparatus needed for image formation to the host broadcasting the image formation request message; and
a second reference generation portion that generates the notice message reference information in which the received image formation response message is reflected.

18. The system as claimed in claim 13, wherein the notice message generation portion generates a notice message code value by coding the notice message and broadcasting the generated notice message code value to the plurality of hosts.

19. The system as claimed in claim 18, further comprising a code value comparison portion that compares the generated notice message code value with the received notice message code value to determine whether the code values are identical,
wherein, in response to the comparison by the code value comparison portion, the notice message processing portion processes the received notice message, generates the notice message code value by coding the processed notice message, and broadcasts the processed notice message and the generated notice message code value to the plurality of hosts.

20. The system as claimed in claim 19, wherein a mismatch between the generated notice message code value and the received generated notice message code value indicates a breach of security during transmission of any of the information of the first wireless network address of the received notice message, the first wireless communication distance, the notice message generation number, and the notice message duration number.

21. A computer-readable recording medium recording a program performing a method of transmitting image data in an ad hoc mode of a wireless communication network including an image forming apparatus and a plurality of hosts, the method comprising:
broadcasting a notice message indicating the presence of the image forming apparatus to the plurality of hosts;
a portion of the plurality of hosts receiving the notice message and broadcasting the received notice message to another portion of the plurality of hosts; and
one of the plurality of hosts receiving the notice message, requesting image formation and transmitting image data to the image forming apparatus.

22. A method of transmitting image data in a wireless communication network, the method comprising:
generating a notice message indicating a presence of an image reproducing apparatus in the wireless communication network;
broadcasting the notice message to a plurality of hosts;
processing the notice message at the plurality of hosts; and
transmitting image data to the image reproducing apparatus,
wherein if one of the plurality of hosts is not within a range of the image reproducing apparatus, using at least one host of the plurality of hosts within the range of the image reproducing apparatus as a router to transmit the image data to the image reproducing apparatus.

23. The method as claimed in claim 22, wherein the notice message comprises a first network address indicating a network address of the image forming apparatus, a first wireless communication distance indicating a distance between the image forming apparatus and a host that receives the notice message, a notice message generation number indicating an order of generation of the notice message, and a notice message duration number indicating a duration of the notice message.

24. The method as claimed in claim 23, wherein the processing of the notice message at the plurality of hosts includes determining whether the plurality of hosts receiving the notice message have notice message reference information related to the image reproducing apparatus.

25. The method as claimed in claim 24, wherein the notice message reference information includes the first network address of the received notice message, the first wireless communication distance of the received notice message, the notice message generation number of the received notice message, and a second network address indicating a network address of the image reproducing apparatus and the plurality of hosts that broadcast the received notice message.

26. The method as claimed in claim 25, wherein when the image reproducing apparatus transmits the notice message, the second network address includes a network address of the image reproducing apparatus.

27. The method of claim 25, wherein when one of the plurality of hosts transmits the notice message, the second network address includes a network address of the one of the plurality of hosts that transmits the notice message.
